(19) United States
(12) Patent Application Publication
(10) Pub. No.: US 2003/0152748 A1
(43) Pub. Date: Aug. 14, 2003

(54) Roof module for a motor vehicle and a method of producing a module

(76) Inventor: Horst Schonebeck, Gelnhausen (DE)

Correspondence Address: CARLSON, GASKEY & OLDS, P.C., 400 WEST MAPLE ROAD, SUITE 350, BIRMINGHAM, MI, 48009, US

(21) Appl. No.: 10/361,153

(22) Filed: Feb. 6, 2003

(30) Foreign Application Priority Data
Feb. 8, 2002 (DE) 102 05 295.6

(51) Int. Cl. B32B 1/00

(52) U.S. Cl. 428/143; 428/292.1

(57) ABSTRACT

The roof module is formed from outer and inner polyurethane layers. The inner polyurethane layer has a first thickness, which is larger than a second thickness of the outer polyurethane layer. The inner layer is injection molded, and the outer layer is then molded to the inner layer. The inner polyurethane layer is molded with an embedded reinforcement material.

This application claims priority to Federal Republic of Germany Patent Application No. 102 05 295.6 filed Feb. 8, 2002.

### TECHNICAL FIELD

The invention relates to a roof module and a method of producing the roof module.

### BACKGROUND OF THE INVENTION

Roof modules known in the prior art have an outer layer and an inner layer, both consisting of a synthetic material. The outer layer of this composite structure is visible from the exterior of the vehicle. Typically, the outer layer is made of a thermoplastic material starting from a plate, which is deep-drawn to a desired shape. Following this deep-drawing process, the outer layer is placed in a foam injection mold. The inner layer is then applied to the inside of the outer layer by an injection molding process. Glass fibers are embedded in the material of the inner layer and provide mechanical strength to the inner layer.

It is quite expensive to ensure that the inner and outer layers reliably adhere to each other across all operational conditions to which the vehicle is exposed. The inner and outer layers have different coefficients of thermal expansion and significant costs arise from efforts to adhere them together. It is also extremely expensive to ensure a high surface quality for the outer layer. The outer layer is part of the vehicle's visible exterior, and the thermoplastic outer layer must have a visual quality similar to the vehicle body.

It is an object of the invention to provide a roof module and method of manufacture, which can be produced inexpensively while still having an outer layer with a high surface quality.

### BRIEF SUMMARY OF THE INVENTION

According to the invention, a roof module for a motor vehicle comprises an outer layer made of polyurethane and an inner layer likewise made of polyurethane. The inner layer has a greater thickness than the outer layer. A reinforcement material further supports the inner layer. High-performance fibers, such as glass fibers, are uniformly embedded to reinforce the inner layer. Because the inner and outer layers are made, for the most part, of the same material, i.e. polyurethane, the two layers have a very close, if not identical coefficients of thermal expansion. Thus, only very low heat-induced tension will occur from variations in temperature experienced by the roof module. Consequently, the invention eliminates expensive intermediate steps for ensuring adequate bonding between the two layers.

In addition, the invention offers a particularly high surface quality at little expense. By polishing or chromium-plating a mold surface of the injection mold, the outer layer is then formed with a matching high quality surface. This technique provides a surprisingly high surface quality that meets the visual requirements for a vehicle exterior at low cost. The cost may be further reduced by mixing a dye in the outer layer material during the molding process.

The inventive method comprises the following steps. First, an insert piece, i.e., the inner layer, is produced by an injection mold from polyurethane and an embedded reinforcement material. Next, the insert piece is then placed in an injection mold. The polyurethane outer layer is then formed to the insert piece.

### BRIEF DESCRIPTION OF THE DRAWINGS

FIG. 1 shows a schematic perspective view of a roof module according to the invention.

FIG. 2 shows a section view along plane II-II of FIG. 1.

FIG. 3 shows a schematic view of the manufacture of the inner layer, which serves as an insert piece.

FIG. 4 shows a sectional view of the inner layer.

FIG. 5 shows schematically how the outer layer is applied to the inner layer.

### DETAILED DESCRIPTION OF THE PREFERRED EMBODIMENT

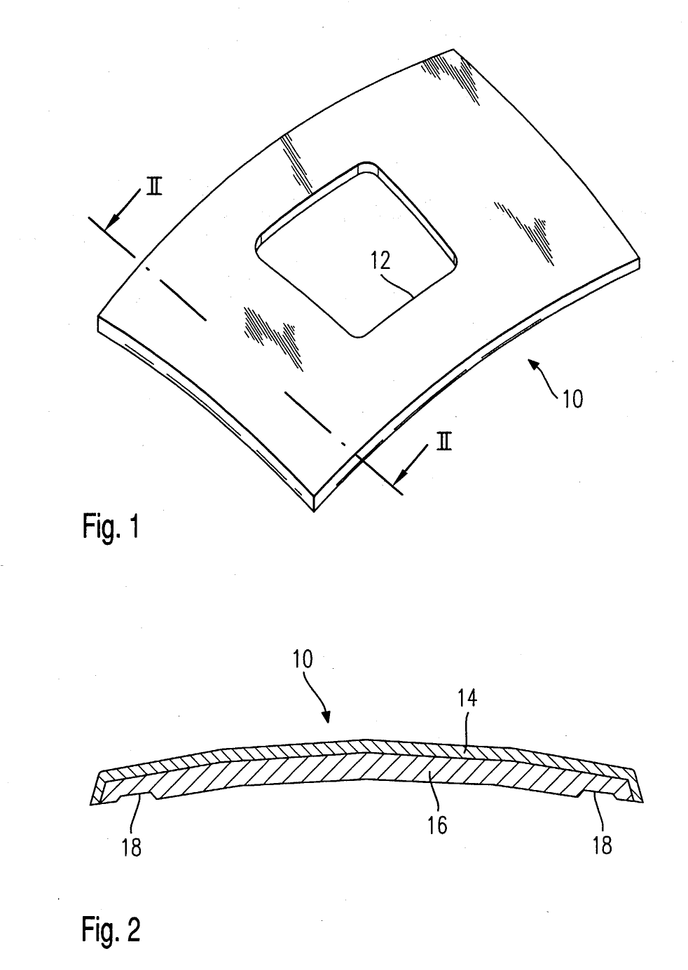

FIG. 1 shows a roof module 10 to be placed and firmly fastened to a vehicle body by, for example, gluing. The roof module 10 has a roof opening 12, in which a cover of a sliding roof may be seated. As shown in FIG. 2, the roof module 10 is a composite part comprising an outer layer 14 and an inner layer 16. The outer layer 14 is foam injection molded from dyed polyurethane and may have a thickness in the range of 1 to 2 millimeters. The inner layer 16 likewise is foam injection molded from polyurethane and has a thickness in the range of 5 to 6 millimeters. The inner layer 16 has reinforcement material, such as glass fibers embedded in its foam. Grooves 18 on the side of the inner layer 16 facing away from the outer layer 14 connect the roof module 10 to the vehicle body.

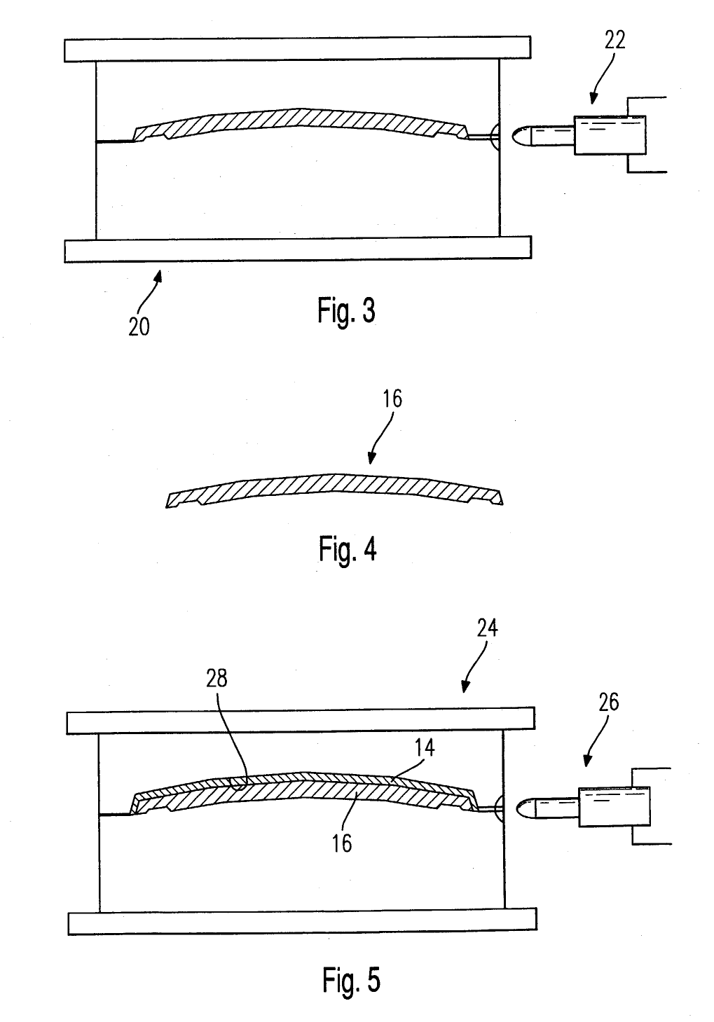

The manufacture of roof module 10 will be explained from FIGS. 3 to 5. A foaming injection mold 20 is used to produce the inner layer 16. Polyurethane and reinforcement material, such as glass fibers, are injected into mold 20 through a mixing head 22. Following curing of the polyurethane, the inner layer 16 is removed and forms an insert piece (see FIG. 4). The insert piece is then placed in a second foaming injection mold 24 as shown in FIG. 5. The second foaming injection mold 24 is injected with polyurethane through a second mixing head 26 to completely cover one side of the inner layer 16 and form the outer layer 14.

While a second mold is specifically disclosed, it should be understood that the insert piece need not be removed. As an example, a mold having two stations, or a two shot molding process could be utilized to form the outer layer.

Forming mold 24 has a formation surface area 28 which will create the outer surface of outer layer 14. Formation surface area 28 has a particularly high surface quality and may be polished or chromium-plated. In this way, the outer layer 14 is formed with high surface quality, which looks absolutely smooth and has no streaks or snakes on the surface.

A main advantage of the method described is that the outer layer 14 can be attached to the inner layer 16 without the need for particular intermediate steps for ensuring a good mechanical adherence between the two layers. A further advantage is that an outer surface area of the outer layer 14 has high visual surface quality at low expense.

The aforementioned description is exemplary rather than limiting. Many modifications and variations of the present invention are possible in light of the above teachings. A preferred embodiment of this invention has been disclosed. However, one of ordinary skill in the art would recognize that certain modifications would come within the scope of this invention. Hence, within the scope of the appended claims, the invention may be practiced otherwise then as specifically described. For this reason, the following claims should be studied to determine the true scope and content of this invention.

1. A roof module for a vehicle, comprising:
an outer polyurethane layer;
an inner polyurethane layer attached to said outer polyurethane layer, said inner polyurethane layer having a first thickness which is greater than a second thickness of said outer polyurethane layer; and
a reinforcement material being embedded said inner polyurethane layer.

2. The roof module of claim 1, wherein said reinforcement material comprises fibers embedded in said inner polyurethane layer.

3. The roof module of claim 2, wherein said reinforcement material comprises glass fibers.

4. The roof module of claim 1, wherein said outer polyurethane layer is provided with a dye.

5. A method of producing a roof module, comprising the steps of:
(a) molding an insert piece from polyurethane and a reinforcement material; and
(b) molding an outer layer of polyurethane onto the polyurethane insert piece.

6. The method of claim 5, wherein steps (a) and (b) occur at different mold stations.

7. The method of claim 5, wherein a dye is mixed with the polyurethane forming the outer layer.

8. The method of claim 5, wherein the mold of step (b) has a polished surface area to shape the outer layer.

9. The method of claim 5, wherein the mold of step (b) has a chromium-plated surface area to shape the outer layer.
